(19) United States
(12) Patent Application Publication
(10) Pub. No.: US 2021/0339398 A1
(43) Pub. Date: Nov. 4, 2021

(54) ROBOT AND METHOD OF OPERATING THE SAME

(71) Applicant: Kawasaki Jukogyo Kabushiki Kaisha, Kobe-shi (JP)

(72) Inventors: Hiroki HASHIMOTO, Shizuoka-shi (JP); Norihisa TSUZAKI, Kakamigahara-shi (JP); Kazuki INUMARU, Kakamigahara-shi (JP); Yuichi AKATSUKA, Kakamigahara-shi (JP); Tomoki OHNO, Kakamigahara-shi (JP)

(73) Assignee: Kawasaki Jukogyo Kabushiki Kaisha, Kobe-shi (JP)

(21) Appl. No.: 17/377,409

(22) Filed: Jul. 16, 2021

Related U.S. Application Data
(63) Continuation of application No. PCT/JP2020/003673, filed on Jan. 31, 2020.

(30) Foreign Application Priority Data
Jan. 31, 2019 (JP) 2019-016243

(51) Int. Cl. B25J 9/16; B25J 13/08; H01R 43/20

(52) U.S. Cl. CPC B25J 9/1687; B25J 9/1633; H01R 13/41; H01R 43/20; B25J 13/085

(57) ABSTRACT

A robot includes: an end effector including a tubular structure and a force sensor; and a controller, the controller to: control the robot holding a terminal to insert the terminal into an insertion hole; control the robot to, after the inserting, position an outer peripheral surface of a distal end of the tubular structure horizontally and bend the tubular structure at a predetermined angle; and control the robot to, after the positioning and bending, advance the end effector through a first distance that is predetermined.

### CROSS-REFERENCE TO RELATED APPLICATIONS

The present application claims priority to PCT/JP2020/003673 filed Jan. 31, 2020, and JP 2019-016243 filed Jan. 31, 2019, both of which are incorporated herein by reference.

### TECHNICAL FIELD

The present disclosure relates to a robot and a method of operating the robot.

### BACKGROUND ART

There is known a housing-holding board of an automatic electric wire-connecting device adapted for production of many types of wire harnesses (see Patent Literature 1, for example). The housing placed on the housing-holding board disclosed in Patent Literature 1 is provided with openings (insertion holes) which communicate with grooves and are arranged in the leftward/rightward direction (in a straight line). Patent Literature 1 states that the grooves are covered by a plate-shaped dummy cover to form dummy cavities, through which an insertion robot is able to introduce terminals into the openings.

### CITATION LIST

### Patent Literature

PTL 1: Japanese Laid-Open Patent Application Publication No. 2003-208960

### SUMMARY

A robot according to the present disclosure is configured to hold a terminal and insert the terminal into a connector having insertion holes to produce a wire harness, the terminal being shaped as a pin or tube, having an outer peripheral surface provided with a projection, and having a proximal end to which a wire is connected, the insertion holes of the connector being stepped to have a smaller opening area at one end of the connector than at the other end of the connector, the robot comprising: an end effector including a tubular structure and a force sensor, the tubular structure including a slit extending in an extension direction of the tubular structure, the tubular structure is bendable relative to the extension direction; and circuitry wherein the tubular structure has an internal space into which the wire and the terminal are inserted, and has a distal end to contact the projection of the terminal, and wherein the circuitry is configured to: control the robot holding the terminal to insert the terminal into the insertion hole; control the robot to, after the inserting of the terminal, position an outer peripheral surface of the distal end of the tubular structure horizontally and bend the tubular structure at a predetermined angle; and control the robot to, after the positioning of the outer peripheral surface of the distal end and the bending of the tubular structure, advance the end effector through a first distance that is predetermined.

A method of operating a robot according to the present disclosure is for operation of a robot configured to hold a terminal and insert the terminal into a connector having insertion holes to produce a wire harness, wherein the robot includes an end effector including a tubular structure and a force sensor, the tubular structure provided with a slit extending in an extension direction of the tubular structure, the tubular structure is bendable relative to the extension direction, wherein the insertion holes of the connector are stepped to have a smaller opening area at one end of the connector than at the other end of the connector, wherein the terminal is shaped as a pin or tube, has an outer peripheral surface provided with a projection, and has a proximal end to which a wire is connected, wherein the tubular structure has an internal space into which the wire and the terminal are inserted, and has a distal end to contact the projection of the terminal, the method including: controlling the robot holding the terminal to insert the terminal into the insertion hole; controlling the robot to, after the inserting of the terminal, position an outer peripheral surface of the distal end of the tubular structure horizontally and bend the tubular structure at a predetermined angle; and controlling the robot to, after the positioning of the outer peripheral surface of the distal end and bending of the tubular structure, advance the end effector through a first distance that is predetermined.

The above and further objects, features and advantages of the present disclosure will be more apparent from the following detailed description of preferred embodiments with reference to the accompanying drawings.

### BRIEF DESCRIPTION OF DRAWINGS

FIG. 1 is a side view schematically showing the general configuration of a robot according to an exemplary embodiment.

FIG. 2A is a schematic view showing an example of an end effector of the robot of FIG. 1.

FIG. 2B is a schematic view showing the example of the end effector of the robot of FIG. 1.

FIG. 3A is a perspective view schematically showing the configuration of a connector.

FIG. 3B is a cross-sectional view of key parts of the connector of FIG. 3A.

FIG. 4A is a part of a flowchart illustrating an example of the operation of the robot according to an exemplary embodiment.

FIG. 4B is a continuation of the flowchart illustrating the example of the operation of the robot according to an exemplary embodiment.

FIG. 4C is a continuation of the flowchart illustrating the example of the operation of the robot according to an exemplary embodiment.

FIGS. 5A to 5C are schematic views showing different states of the tubular structure of the robot operating according to the flowchart shown in FIGS. 4A and 4B.

FIG. 6 is a schematic view showing a state of the tubular structure of the robot operating according to the flowchart shown in FIGS. 4A and 4B.

FIG. 7 is a schematic view showing a state of the tubular structure of the robot operating according to the flowchart shown in FIGS. 4A and 4B.

FIG. 8A is a part of a flowchart illustrating an example of the operation of a robot according to an exemplary embodiment.

FIG. 8B is a continuation of the flowchart illustrating the example of the operation of a robot according to an exemplary embodiment.

FIG. 8C is a continuation of the flowchart illustrating the example of the operation of the robot according to an exemplary embodiment.

### DESCRIPTION OF EMBODIMENTS

Hereinafter, exemplary embodiments of the present disclosure will be described with reference to the drawings. The same or equivalent elements are denoted by the same reference signs throughout the drawings, and repeated descriptions of these elements will not be given. In the drawings, some elements may be selectively shown to illustrate the present disclosure while the other elements are omitted from the figure. The present disclosure is not limited to the embodiments described below.

A robot according to an exemplary embodiment is configured to hold a terminal and insert the terminal into a connector having insertion holes to produce a wire harness, and includes: an end effector including a tubular structure and a force sensor, the tubular structure being provided with a slit extending in an extension direction of the tubular structure, the tubular structure being bendable relative to the extension direction; and a controller. The insertion hole of the connector is stepped to have a smaller opening area at one end than at the other end. The terminal is in the form of a pin or tube, has an outer peripheral surface provided with a projection, and has a proximal end to which a wire is connected. The tubular structure has an internal space into which the wire and the terminal are inserted, and has a distal end adapted to contact the projection of the terminal. The controller is configured to: (A) cause the robot holding the terminal to insert the terminal into the insertion hole; (B) cause the robot to, after the inserting (A), position an outer peripheral surface of the distal end of the tubular structure horizontally and bend the tubular structure at a predetermined angle; and (C) cause the robot to, after the positioning and bending (B), advance the end effector through a first distance that is predetermined.

In the robot according to an exemplary embodiment, the distal end of the tubular structure may be tapered.

In the robot according to an exemplary embodiment, the insertion holes of the connector may be arranged in a direction perpendicular to the extension direction.

In the robot according to an exemplary embodiment, the insertion holes of the connector may be arranged in a peripheral direction of the connector.

In the robot according to an exemplary embodiment, the controller may be configured to, in the positioning and bending (B): (B1) cause the robot to angularly move the tubular structure in a first direction about a first point of the tubular structure through a first angle that is predetermined, the first direction being opposite to a direction in which the slit is located; and (B2) cause the robot to, after the angularly moving (B1), angularly move the tubular structure in the first direction about the distal end of the tubular structure through a second angle that is predetermined and thereby position the outer peripheral surface of the distal end of the tubular structure horizontally.

In the robot according to an exemplary embodiment, the controller may be configured to (D) cause the robot to, after the advancing (C), remove the tubular structure from the insertion hole if the force sensor detects a force smaller than a first threshold that is predetermined.

In the robot according to an exemplary embodiment, the controller may be configured to (E) cause the robot to move the end effector in the first direction after the removing (D).

In the robot according to an exemplary embodiment, the controller may be configured to, in the advancing (C): (C1) cause the robot to, upon detection of a force equal to or greater than the first threshold by the force sensor, withdraw the end effector until the force sensor detects a force smaller than the first threshold; (C2) cause the robot to, after the withdrawing (C1), move the end effector in a direction different from the direction of advancement and withdrawal of the end effector; and (C3) cause the robot to advance the end effector after the moving (C2).

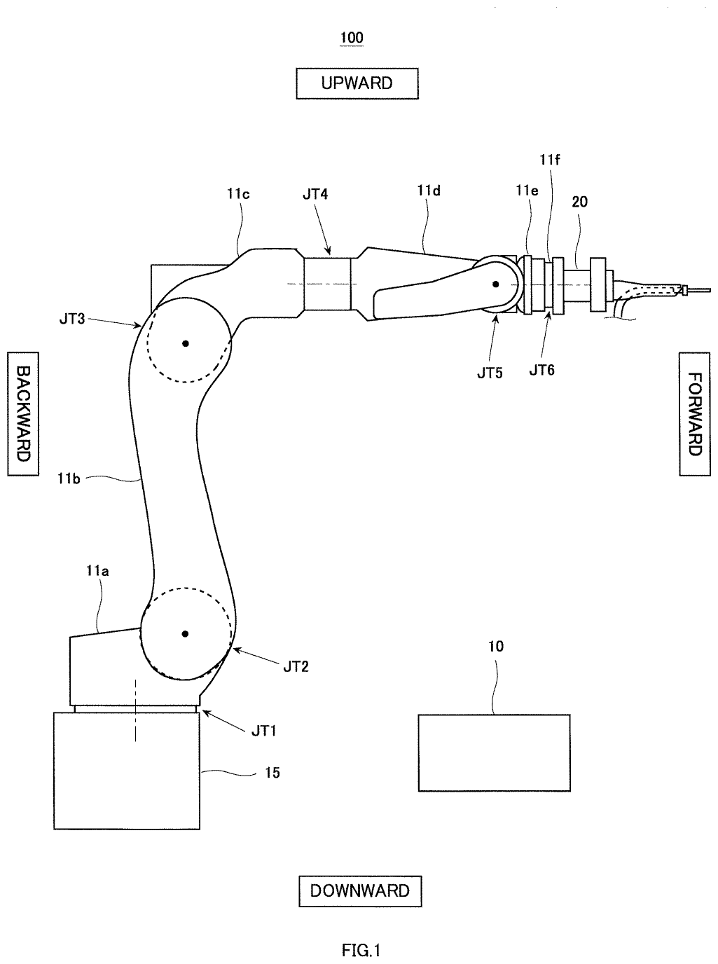

Hereinafter, an example of the robot according to an exemplary embodiment will be described with reference to FIGS. 1 to 7.

### Configuration of Robot

FIG. 1 is a side view schematically showing the general configuration of the robot according to an exemplary embodiment. The upward/downward and forward/backward directions indicated in FIG. 1 are those defined with respect to the robot.

As shown in FIG. 1, a robot 100 according to an exemplary embodiment is a vertical articulated robot arm including serially coupled links (first to sixth links 11a to 11f in this example), joints (first to sixth joints JT1 to JT6 in this example), a support base 15 supporting the links and the joints, and a controller 10. The robot 100 according to an exemplary embodiment is configured to, under control of the controller 10, insert a terminal 31 held by an end effector 20 into an insertion hole 44 of a connector 40 to produce a wire harness.

Although in an exemplary embodiment a vertical articulated robot arm is employed as the robot 100, the robot 100 is not limited to this type of robot and may be a horizontal articulated robot. In that case, the robot 100 may include a mechanical interface configured to allow the end effector 20 to swing in the upward/downward direction.

The first joint JT1 couples the support base 15 and the proximal end of the first link 11a in a manner permitting rotational motion about an axis extending in the vertical direction. The second joint JT2 couples the distal end of the first link 11a and the proximal end of the second link 11b in a manner permitting rotational motion about an axis extending in the horizontal direction. The third joint JT3 couples the distal end of the second link 11b and the proximal end of the third link 11c in a manner permitting rotational motion about an axis extending in the horizontal direction.

The fourth joint JT4 couples the distal end of the third link 11c and the proximal end of the fourth link 11d in a manner permitting rotational motion about an axis extending in the longitudinal direction of the fourth link 11d. The fifth joint JT5 couples the distal end of the fourth link 11d and the proximal end of the fifth link 11e in a manner permitting rotational motion about an axis perpendicular to the longitudinal direction of the fourth link 11d. The sixth joint JT6 couples the distal end of the fifth link 11e and the proximal end of the sixth link 11f in a manner permitting torsional motion.

The distal end of the sixth link 11f is equipped with a mechanical interface. The end effector 20 adapted for the intended task is removably mounted on the mechanical interface. The configuration of the end effector 20 will be described later.

Each of the first to sixth joints JT1 to JT6 is equipped with a drive motor (not shown), which is an example of an actuator for effecting relative rotation between the two elements connected by the joint. The drive motor may be, for example, a servomotor servo-controlled by the controller 10. Each of the first to sixth joints JT1 to JT6 is equipped with a rotational sensor (not shown) for detecting the rotational position of the drive motor and a current sensor (not shown) for detecting an electric current for control of the rotation of the drive motor. The rotational sensor may be, for example, an encoder.

The controller 10 includes a processor (not shown) such as a microprocessor or CPU and a memory (not shown) such as a ROM or RAM. The memory stores information such as a basic program and various fixed data. The processor retrieves software such as the basic program from the memory and executes the software to control various motions of the robot 100.

The controller 10 may consist of a single controller 10 that performs centralized control or may be constituted by controllers 10 cooperative with one another to achieve distributed control. The controller 10 may be embodied, for example, by a microcomputer, an MPU, a programmable logic controller (PLC), or a logic circuit. The functionality of the elements disclosed herein including but not limited to the controller 10 may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Configuration of End Effector

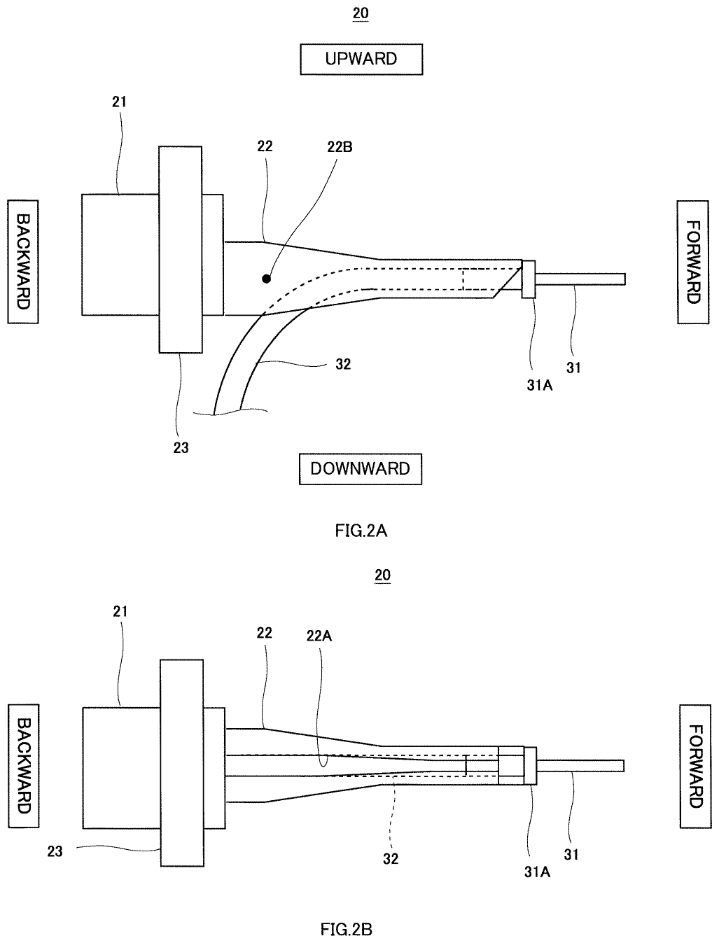

The configuration of the end effector 20 will now be described in detail with reference to FIGS. 2A and 2B.

FIGS. 2A and 2B are schematic views showing an example of the end effector of the robot of FIG. 1. FIG. 2A is a side view of the end effector, and FIG. 2B is a bottom view of the end effector. The forward/backward and upward/downward directions indicated in FIG. 2A are those defined with respect to the robot. The forward/backward direction indicated in FIG. 2B is that defined with respect to the robot.

As shown in FIGS. 2A and 2B, the end effector 20 includes a box-shaped base 21, a tubular structure 22, and a force sensor 23 and is configured to hold the terminal 31 and a wire 32 firmly fastened (connected) to the proximal end of the terminal 31. The terminal 31 is in the form of a pin or tube (socket), and has an outer peripheral surface provided with a flange-shaped projection 31A.

The tubular structure 22 is provided with a slit 22A formed in the underside of the tubular structure 22 and extending in the extension direction of the tubular structure 22 (forward/backward direction in this example). The terminal 31 and wire 32 are placed into and taken out of the internal space of the tubular structure 22 through the slit 22A of the tubular structure 22.

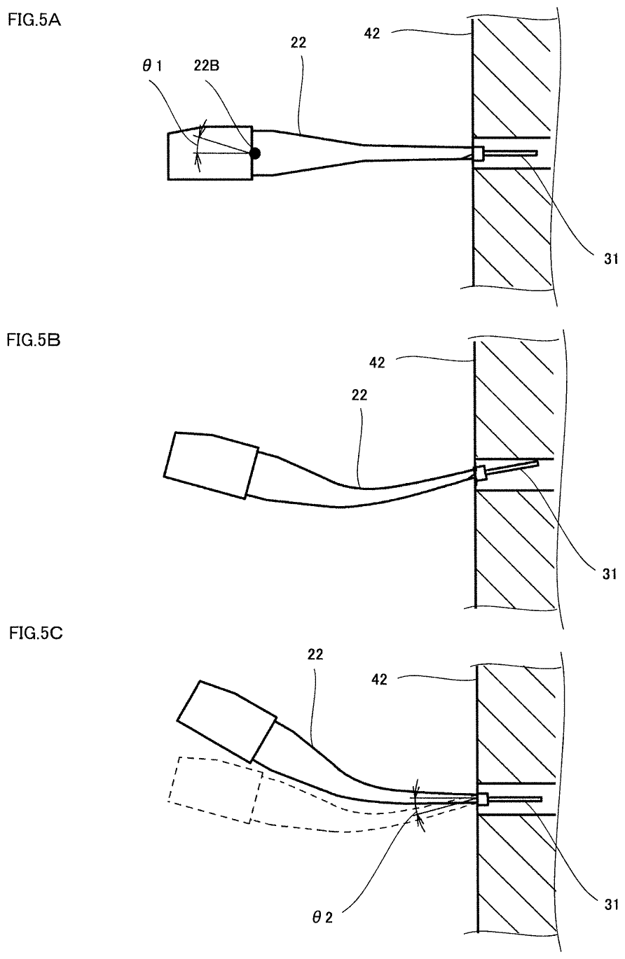

The tubular structure 22 is made of, for example, plastic, and bendable relative to the extension direction (see FIG. 5). Further, the lower portion of the distal end of the tubular structure 22 is cut, and the upper portion of the distal end is brought into contact with the upper portion of the rear end of the projection 31A of the terminal 31. That is, the distal end of the tubular structure 22 is tapered.

The force sensor 23 is configured to detect a reactive force acting on the end effector 20 from outside or an outward force exerted by the end effector 20 and output the components of the detected force (force information or pressure information) to the controller 10.

### Configuration of Connector

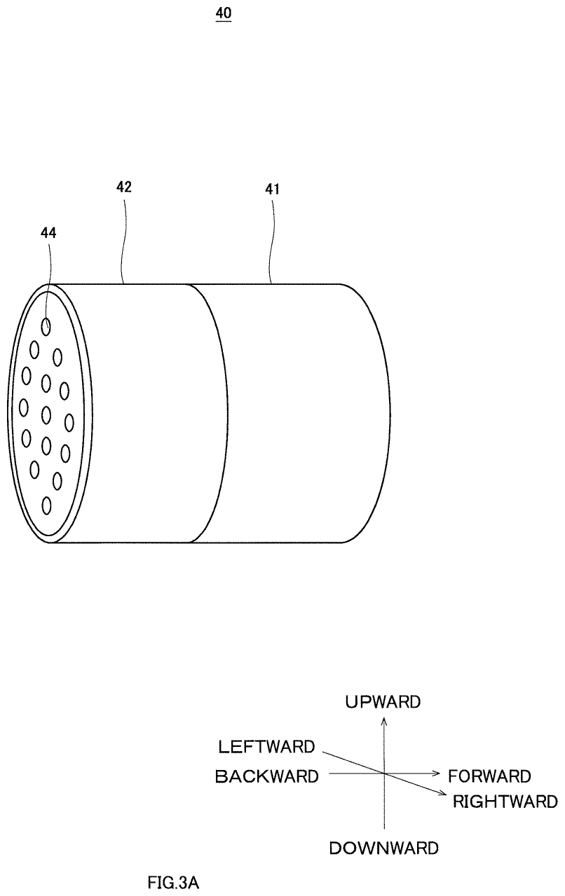

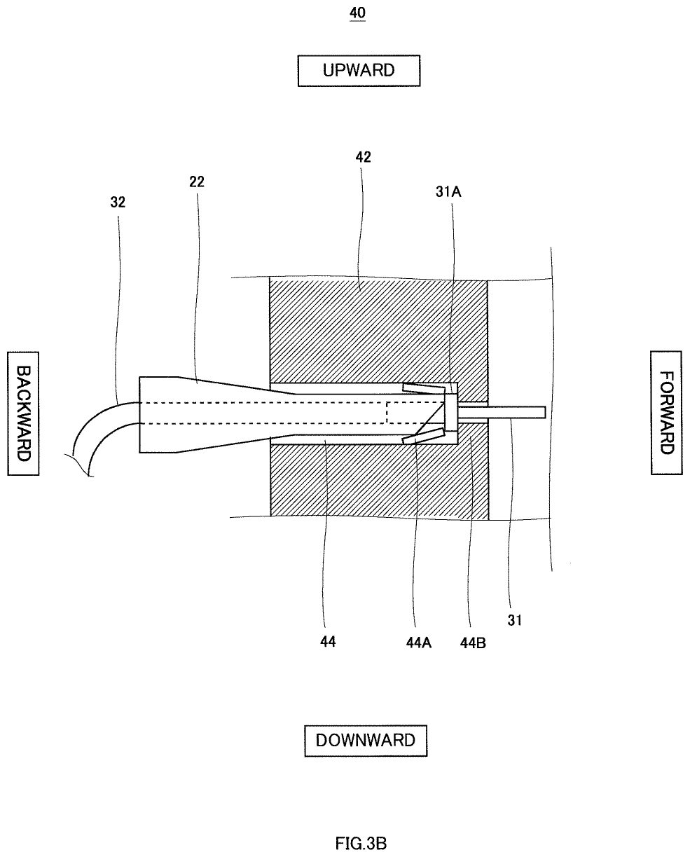

The configuration of the connector 40 will now be described with reference to FIGS. 3A and 3B.

FIG. 3A is a perspective view schematically showing the configuration of the connector 40. FIG. 3B is a cross-sectional view of key parts of the connector of FIG. 3A. The forward/backward, leftward/rightward, and upward/downward directions indicated in FIG. 3A are those defined with respect to the connector 40. The forward/backward and upward/downward directions indicated in FIG. 3B are those defined with respect to the connector 40.

As shown in FIGS. 3A and 3B, the connector 40 includes a first structure 41 in the form of a hollow cylinder (a hollow circular cylinder in this example) and a second structure 42 in the form of a solid cylinder (a solid circular cylinder in this example). The second structure 42 is provided with insertion holes 44 extending in the forward/backward direction. The insertion holes 44 may, for example, be arranged in a direction (the upward/downward and/or leftward/rightward direction in this example) perpendicular to the extension direction of the tubular structure 22 (the forward/backward direction in this example) or arranged in the peripheral direction (the circumferential direction in this example) of the connector 40.

The insertion hole 44 is formed to have a smaller opening area at its end facing the first structure 41 than at the other end facing away from the first structure 41. This means that the insertion hole 44 is stepped. In other words, the insertion hole 44 is provided with a stepped portion 44B. The insertion hole 44 is further provided with a lock mechanism 44A to lock the projection 31A and thereby lock the terminal 31 in the insertion hole 44 once the terminal 31 is properly inserted into the insertion hole 44.

### Operation and Benefits of the Robot

Hereinafter, the operation and benefits of the robot 100 according to an exemplary embodiment will be described with reference to FIGS. 1 to 7. The operation described below is carried out by the controller's 10 processor retrieving and executing the program stored in the memory. The operation described below is an example in which the controller 10 causes the robot 100 to position the outer peripheral surface of the distal end of the tubular structure 22 horizontally and bend the tubular structure 22 at a predetermined angle.

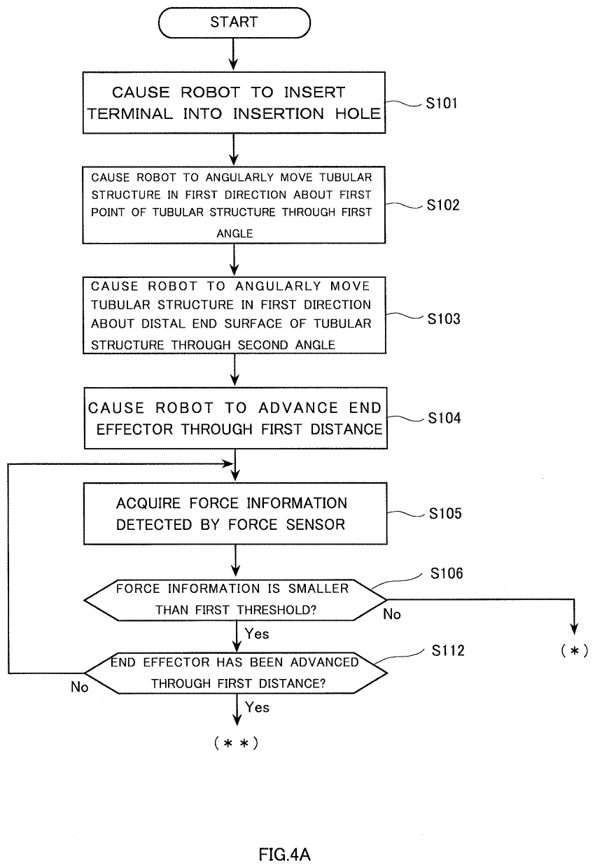

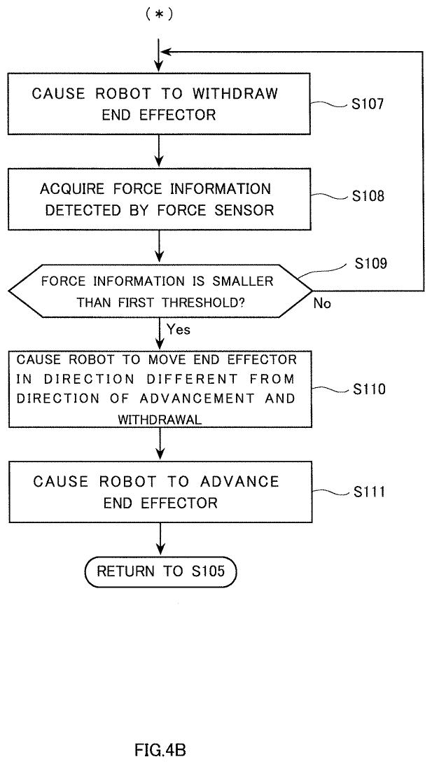

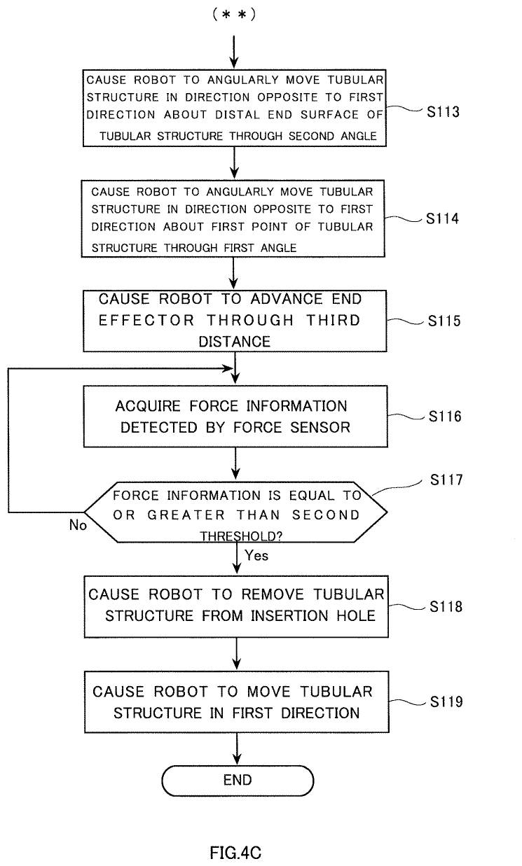

FIGS. 4A to 4C show a flowchart illustrating an example of the operation of the robot according to an exemplary embodiment. FIGS. 5 to 7 are schematic views showing different states of the tubular structure of the robot operating according to the flowchart shown in FIGS. 4A to 4C.

First, it is assumed that command information representing the command to carry out the task of holding the terminal 31 and the wire 32 and inserting the terminal 31 into the insertion hole 44 of the connector 40 has been input by an operator through an input device.

Upon the input of the command information, the controller 10 causes the robot 100 to, as shown in FIG. 4A, hold the terminal 31 and wire 32 in the tubular structure 22 of the end effector 20 and insert the held terminal 31 into the insertion hole 44 of the connector 40 (step S101).

The holding of the terminal 31 and wire 32 in the tubular structure 22 may be accomplished with the aid of an end effector different from the end effector 20 shown in FIG. 2A and other figures. That is, the robot 100 according to an exemplary embodiment may be equipped with a different end effector and use this end effector to cause the end effector 20 to hold the terminal 31 and wire 32. A robot different from the robot 100 according to the present embodiment may be operated to cause the end effector 20 to hold the terminal 31 and wire 32.

A robot having arms may be used. In this case, the end effector 20 may be mounted on one of the arms while end effectors different from the end effector 20 are mounted on the other arms, and the end effectors different from the end effector 20 may be used to cause the end effector 20 to hold the terminal 31 and wire 32. The worker (operator) may carry out the task of causing the end effector 20 to hold the terminal 31 and wire 32.

Next, the controller 10 causes the robot 100 to angularly move the tubular structure 22 in a first direction (upward direction in this example) about a first point 22B of the tubular structure 22 through a first angle θ1 (step S102; see FIG. 5A). The first direction is opposite to the direction in which the slit 22A opens.

The first point 22B may be at any location in the tubular structure 22 as long as the tubular structure 22 is bent relative to the extension direction. The first point 22B is predetermined as appropriate by means such as experimentation. In an exemplary embodiment, the first point 22B is located on the axis of the tubular structure 22 (or the axis of the terminal 31) and in a rear end portion of the tubular structure 22. Specifically, denoting the length of the tubular structure 22 in the extension direction by L, the first point 22B may, for example, be located at a distance of ¼ to ⅓L from the rear end of the tubular structure 22 in order to prevent damage to the tubular structure 22.

The first angle θ1 can be predetermined by means such as experimentation, and may be, for example, from 0.5 to 20° or from 5 to 12°. The controller 10 may cause the robot 100 to accomplish the movement through the first angle θ1 in one stage. Alternatively, the controller 10 may cause the robot 100 to accomplish the movement through the first angle θ1 in multiple stages. For example, the controller 10 may cause the robot 100 to accomplish the movement through the first angle θ1 by angularly moving the tubular structure 22 by 0.1° increments.

In consequence of the above angular movement, the tubular structure 22 is bent relative to the extension direction as shown in FIG. 5B. In this state, the distal end of the tubular structure 22 faces upward. Thus, advancing the end effector 20 (tubular structure 22) in this state could lead to contact of the terminal 31 with a vertical surface 44C of the stepped portion 44B of the insertion hole 44 of the second structure 42. To avoid this contact, the controller 10 carries out step S103.

In step S103, the controller 10 causes the robot 100 to angularly move the tubular structure 22 in the first direction about the distal end surface of the tubular structure 22 (or the point of the distal end surface that is located on the axis of the tubular structure 22) through a second angle θ2. This allows the outer peripheral surface of the distal end of the bent tubular structure 22 (or the axis of the terminal 31) to be positioned horizontally. Thus, contact of the terminal 31 with the vertical surface 44C of the stepped portion of the insertion hole 44 can be prevented. As a result of the bending of the tubular structure 22, the distal end of the tubular structure 22 presses the projection 31A of the terminal 31 obliquely downward.

The second angle θ2 can be predetermined by means such as experimentation, and may be, for example, from 0.5 to 20° or from 5 to 12°. The controller 10 may cause the robot 100 to accomplish the movement through the second angle θ2 in one stage. Alternatively, the controller 10 may cause the robot 100 to accomplish the movement through the second angle θ2 in multiple stages. For example, the controller 10 may cause the robot 100 to accomplish the movement through the second angle θ2 by angularly moving the tubular structure 22 by 0.1° increments.

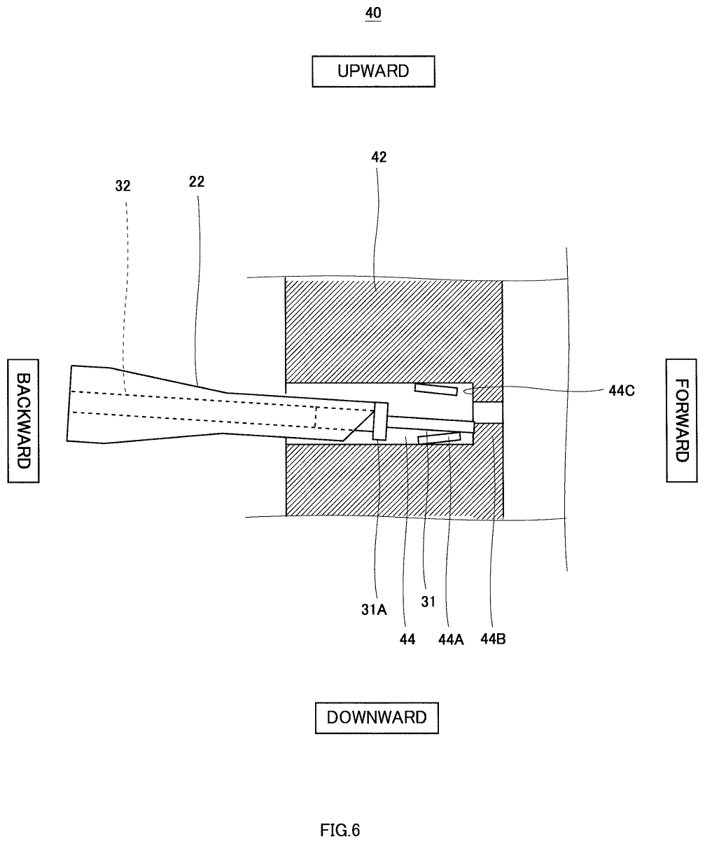

Depending on the precision error of the robot 100, tubular structure 22, and connector 40, the outer peripheral surface of the distal end of the tubular structure 22 (or the axis of the terminal 31) could fail to be positioned horizontally, with the result that the distal end of the terminal 31 could contact the vertical surface 44C of the stepped portion 44B of the second structure 42 in a manner as shown in FIG. 6.

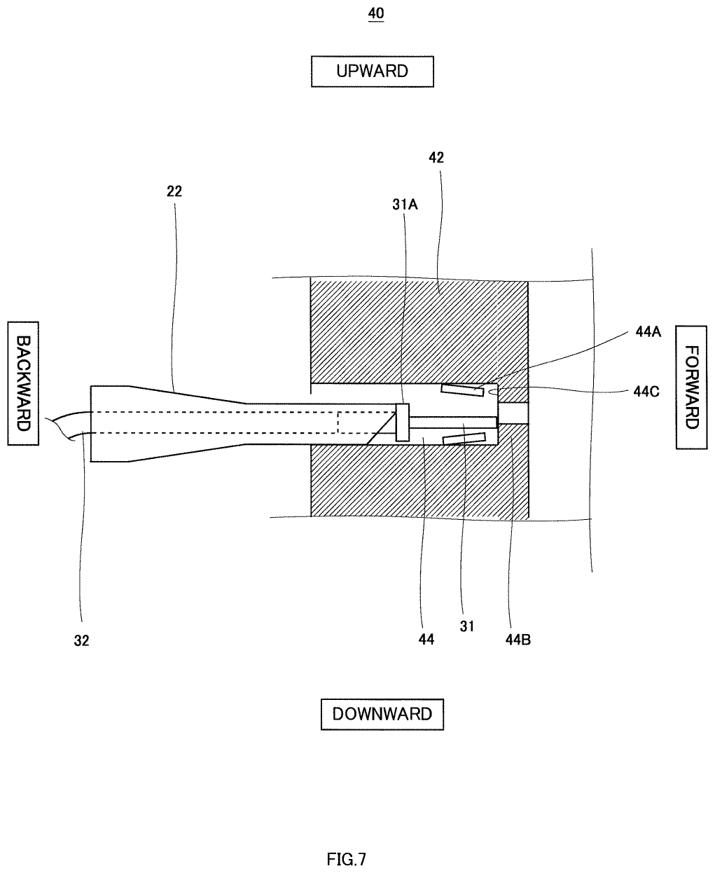

Further, depending on the precision error of the robot 100, tubular structure 22, and connector 40, the outer peripheral surface of the distal end of the tubular structure 22 (or the axis of the terminal 31) could fail to be directed in the horizontal direction, with the result that the distal end of the terminal 31 could contact the vertical surface 44C of the stepped portion 44B of the second structure 42 in a manner as shown in FIG. 7.

Next, the controller 10 causes the robot 100 to advance the end effector 20 through a first distance (step S104). The first distance can be predetermined by means such as experimentation, and an appropriate value of the first distance can be chosen based on the length of the insertion hole 44 in the extension direction and the lengths of the terminal 31 and tubular structure 22 in the extension direction. Specifically, the first distance corresponds to the distance to a location which is slightly beyond the vertical surface 44C of the second structure 42, and the distal end of the terminal 31 is brought to this location by the advancement of the end effector 20.

Next, the controller 10 acquires force information detected by the force sensor 23 (step S105). Subsequently, the controller 10 determines whether the force information acquired in step S105 is smaller than a first threshold (step S106). The first threshold can be predetermined by means such as experimentation, and is the value of the pressure generated upon contact of the distal end of the terminal 31 with the vertical surface 44C.

Upon determining that the force information acquired in step S105 is not smaller than the first threshold (No in step S106), the controller 10 causes the robot 100 to withdraw the end effector 20 (step S107). Subsequently, the controller 10 acquires force information detected by the force sensor 23 (step S108) and determines whether the force information acquired in step S108 is smaller than the first threshold (step S109).

Upon determining that the force information acquired in step S108 is not smaller than the first threshold (No in step S109), the controller 10 repeats steps S107 to S109 until the force information acquired in step S108 falls below the first threshold.

Upon determining that the force information acquired in step S108 is smaller than the first threshold (Yes in step S109), the controller 10 causes the robot 100 to move the end effector 20 in a given direction different from the direction of advancement and withdrawal of the end effector 20 (step S110).

The given direction includes at least one of the upward, downward, rightward, and leftward directions and may be a combination of one of the upward and downward directions and one of the leftward and rightward directions. When, as described later, step S110 is repeated in response to the result of step S112, the given direction may vary between step S110 performed for the first time and step S110 performed for the second and subsequent times.

Next, the controller 10 causes the robot 100 to advance the end effector 20 (step S111). After that, the controller 10 returns to step S105 and acquires force information detected by the force sensor 23.

Upon determining that the force information acquired in step S105 is smaller than the first threshold (Yes in step S106), the controller 10 determines whether the end effector 20 has been advanced through the first distance (step S112). Specifically, the controller 10 calculates positional information of the distal end of the end effector 20 from rotation information acquired from the rotational sensors mounted on the joints of the robot 100, and determines, based on the positional information, whether the end effector 20 has been advanced through the first distance.

Upon determining that the end effector 20 has not been advanced through the first distance (No in step S112), the controller 10 repeats steps S105 to S112 until the end effector 20 is determined to have been advanced through the first distance.

Upon determining that the end effector 20 has been advanced through the first distance (Yes in step S112), the controller 10 causes the robot 100 to stop the advancement of the end effector 20 and carries out step S113.

In step S113, the controller 10 causes the robot 100 to angularly move the tubular structure 22 in a second direction opposite to the first direction (the second direction is the direction in which the slit 22A opens, and is the downward direction in this example) about the distal end surface of the tubular structure 22 (or the point of the distal end surface that is located on the axis of the tubular structure 22) through the second angle θ2. Thus, the end effector 20 is returned to the angular position in which it was placed before the angular movement in step S103.

Next, the controller 10 causes the robot 100 to angularly move the tubular structure 22 in the second direction about the first point of the tubular structure 22 through the first angle θ1 (step S114). Thus, the end effector 20 is returned to the angular position in which it was placed before the angular movement in step S102. That is, the controller 10 can return the end effector 20 to the substantially horizontal position by carrying out steps S113 and S114.

Next, the controller 10 causes the robot 100 to advance the end effector 20 forward through a third distance (step S115). The third distance can be predetermined by means such as experimentation, and an appropriate value of the third distance can be chosen based on the length of the insertion hole 44 in the extension direction and the lengths of the terminal 31 and tubular structure 22 in the extension direction. Specifically, the third distance corresponds to the distance to a location ahead of the location at which the end surface of the projection 31A facing the distal end of the terminal 31 is brought into contact with the vertical surface 44C by the advancement of the end effector 20.

Next, the controller 10 acquires force information detected by the force sensor 23 (step S116). Subsequently, the controller 10 determines whether the force information acquired in step S116 is equal to or greater than a second threshold (step S117). The second threshold can be predetermined by means such as experimentation, and is the value of the pressure generated upon contact of the end surface of the projection 31A facing the distal end of the terminal 31 with the vertical surface 44C.

If determining that the force information acquired in step S116 is smaller than the second threshold (No in step S117), the controller 10 repeats steps S116 and S117 until the force information acquired in step S116 becomes equal to or greater than the second threshold.

Upon determining that the force information acquired in step S116 is equal to or greater than the second threshold (Yes in step S117), the controller 10 causes the robot 100 to withdraw the end effector 20, in particular to remove the tubular structure 22 from the insertion hole 44 (step S118).

Next, the controller 10 causes the robot 100 to move the tubular structure 22 (end effector 20) in the first direction (step S119), and then ends the program. Thus, the wire 32 held in the internal space of the tubular structure 22 during the program is let out of the tubular structure 22 through the slit 22A.

In step S118, the controller 10 may cause the robot 100 to withdraw the tubular structure 22 while moving the tubular structure 22 in the first direction.

In the robot 100 according to an exemplary embodiment, as described above, the controller 10 is configured to cause the robot 100 to angularly move the tubular structure 22 in the first direction about the first point 22B of the tubular structure 22 through the first angle θ1 and subsequently cause the robot 100 to angularly move the tubular structure 22 in the first direction about the distal end surface of the tubular structure 22 (or the point of the distal end surface that is located on the axis of the tubular structure 22) through the second angle θ2.

Thus, the tubular structure 22 is bent to allow its distal end to press the projection 31A of the terminal 31 obliquely downward. As such, in the event that the distal end of the terminal 31 comes into contact with the vertical surface 44C of the second structure 42, the distal end of the tubular structure 22 is prevented from moving beyond the projection 31A of the terminal 31 to let the terminal 31 enter the internal space of the tubular structure 22.

If the terminal 31 enters the internal space of the tubular structure 22, the terminal 31 engages with the inner wall surface of the tubular structure 22. When the robot 100 is caused to withdraw the end effector 20 in this state, the tubular structure 22 is withdrawn with the terminal 31 residing in the internal space of the tubular structure 22.

Thus, the projection 31A of the terminal 31 cannot be moved ahead of the distal end of the tubular structure 22 and pushed into the lock mechanism 44A of the second structure 42.

To allow the projection 31A of the terminal 31 to move ahead of the distal end of the tubular structure 22, it is preferred to remove the tubular structure 22 from the insertion hole 44 and start over from the holding of the terminal 31 at the first point 22B. Hence, the entry of the terminal 31 into the internal space of the tubular structure 22 results in an increase in the time for production of wire harnesses.

With the robot 100 according to an exemplary embodiment, the entry of the terminal 31 into the internal space of the tubular structure 22 can be prevented, and therefore the increase in the time for production of wire harnesses can be avoided. Additionally, the terminal 31 can be inserted into the connector 40 having the insertion holes 44 which are arranged in the forward/backward and leftward/rightward directions, with respect to which the terminal is difficult to accurately position, and each of which has an interior provided with a stepped portion.

Additionally, in the robot 100 according to an exemplary embodiment, the distal end of the tubular structure 22 is tapered. In other words, the distal end of the tubular structure 22 is partially cut. Thus, the portion of the projection 31A (the lower portion of the projection 31A in this example) that faces the cut portion of the tubular structure 22 can be brought into contact with the lock mechanism 44A of the second structure 42 to effect the locking function.

A robot according to another exemplary embodiment is based on the robot according to the exemplary embodiment discussed above, and the controller of the robot according to this exemplary embodiment is configured to, in the withdrawing (C1), cause the robot to withdraw the end effector through a second distance smaller than the first distance.

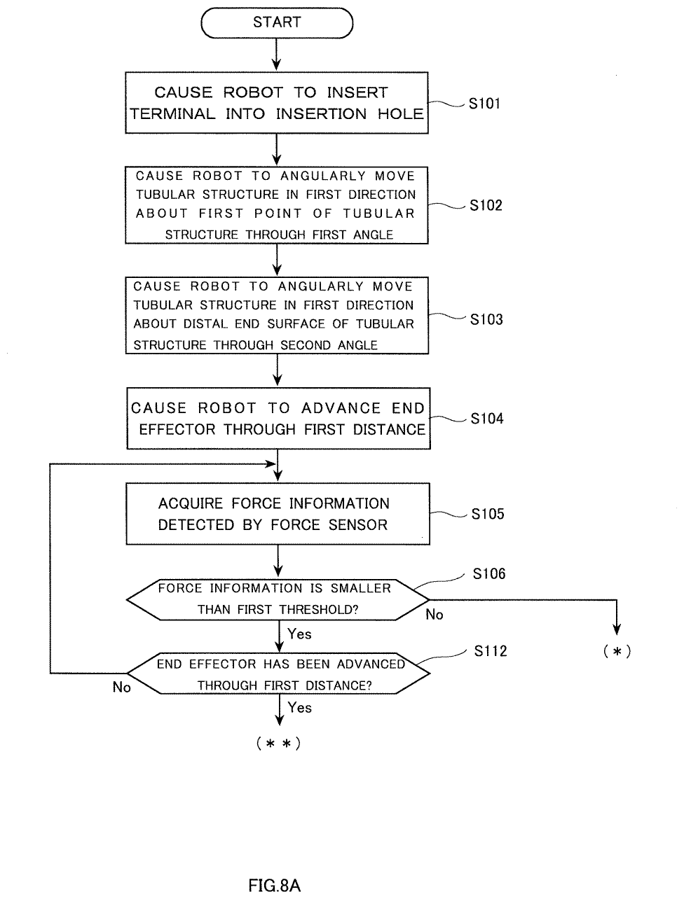

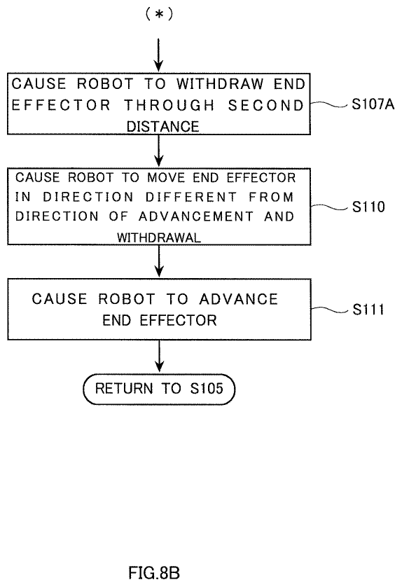

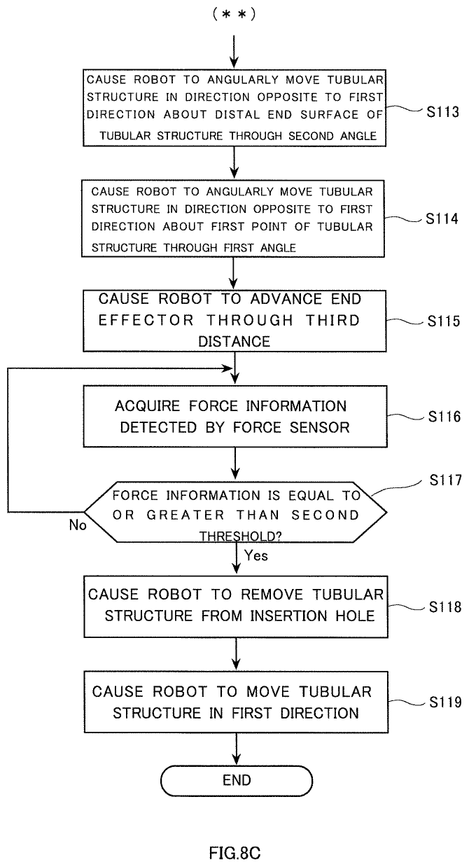

Hereinafter, an example of the robot according to this exemplary embodiment will be described with reference to FIGS. 8A to 8C. The basic configuration of the robot according to this exemplary embodiment is the same as that of the robot according to the previous exemplary embodiment and will therefore not be described in detail.

### Operation and Benefits of Robot

FIGS. 8A to 8C show a flowchart illustrating an example of the operation of the robot according to this exemplary embodiment.

As seen from FIGS. 8A to 8C, the operation of the robot 100 according to this exemplary embodiment is essentially the same as that of the robot 100 according to the previous exemplary embodiment, but differs in the procedure that the controller 10 performs upon determining that the force information acquired in step S105 is not smaller than the first threshold (No in step S106).

Specifically, upon determining that the force information acquired in step S105 is not smaller than the first threshold (No in step S106), the controller 10 causes the robot 100 to withdraw the end effector 20 through a second distance smaller than the first distance (step S107A). The second distance can be predetermined by means such as experimentation. The second distance may be smaller than the length of the insertion hole 44A of the second structure 42 in the extension direction or may be equal to or smaller than the distance from the front end of the second structure 42 to the lock mechanism 44A.

Next, the controller 10 causes the robot 100 to move the end effector 20 in a given direction different from the direction of advancement and withdrawal of the end effector 20 (step S110). Subsequently, the controller 10 causes the robot 100 to advance the end effector 20 (step S111), and then returns to step S105.

The thus-configured robot 100 according to this exemplary embodiment offers the same benefits as the robot 100 according to the previous exemplary embodiment.

With the robot and its operating method of the present disclosure, terminals can be inserted into a connector having insertion holes which are arranged in the leftward/rightward and upward/downward directions and each of which has an interior provided with a stepped portion.

Many modifications and other embodiments of the present disclosure will be apparent to those skilled in the art from the foregoing description. Accordingly, the foregoing description is to be construed as illustrative only, and is provided for the purpose of teaching those skilled in the art the best mode for carrying out the disclosure. The details of the structure and/or function may be varied substantially without departing from the scope of the disclosure.

### INDUSTRIAL APPLICABILITY

With the robot and its operating method of the present disclosure, terminals can be inserted into a connector having insertion holes which are arranged in the leftward/rightward and upward/downward directions and each of which has an interior provided with a stepped portion. The robot and method of the present disclosure are therefore useful in the robot industry.

### REFERENCE SIGNS LIST

10 controller

11a first link

11b second link

11c third link

11d fourth link

11e fifth link

11f sixth link

15 support base

20 end effector

21 base

22 tubular structure

22A slit

22B first point

23 force sensor

31 terminal

31A projection

wire

40 connector

41 first structure

42 second structure

44 insertion hole

44A lock mechanism

44B projection

44C vertical surface

100 robot

JT1 first joint

JT2 second joint

JT3 third joint

JT4 fourth joint

JT5 fifth joint

JT6 sixth joint

1. A robot configured to hold a terminal and insert the terminal into a connector having insertion holes to produce a wire harness, the terminal being shaped as a pin or tube, having an outer peripheral surface provided with a projection, and having a proximal end to which a wire is connected, the insertion holes of the connector being stepped to have a smaller opening area at one end of the connector than at the other end of the connector, the robot comprising:
an end effector including a tubular structure and a force sensor, the tubular structure including a slit extending in an extension direction of the tubular structure, the tubular structure is bendable relative to the extension direction; and
circuitry
wherein the tubular structure has an internal space into which the wire and the terminal are inserted, and has a distal end to contact the projection of the terminal, and
wherein the circuitry is configured to:
control the robot holding the terminal to insert the terminal into the insertion hole;
control the robot to, after the inserting of the terminal, position an outer peripheral surface of the distal end of the tubular structure horizontally and bend the tubular structure at a predetermined angle; and
control the robot to, after the positioning of the outer peripheral surface of the distal end and the bending of the tubular structure, advance the end effector through a first distance that is predetermined.

2. The robot according to claim 1, wherein the distal end of the tubular structure is tapered.

3. The robot according to claim 1, wherein the insertion holes of the connector are located in a direction perpendicular to the extension direction.

4. The robot according to claim 1, wherein the insertion holes of the connector are located in a peripheral direction of the connector.

5. The robot according to claim 1, wherein the circuitry is configured to, in the positioning of the outer peripheral surface of the distal end and the bending of the tubular structure:
control the robot to angularly move the tubular structure in a first direction about a first point of the tubular structure through a first angle that is predetermined, the first direction being opposite to a direction in which the slit is located; and
control the robot to, after the angularly moving of the tubular structure, angularly move the tubular structure in the first direction about the distal end of the tubular structure through a second angle that is predetermined and thereby position the outer peripheral surface of the distal end of the tubular structure horizontally.

6. The robot according to claim 1, wherein the circuitry is configured to control the robot to, after the advancing of the end effector, remove the tubular structure from the insertion hole if the force sensor detects a force smaller than a first threshold that is predetermined.

7. The robot according to claim 6, wherein the circuitry is configured to control the robot to move the end effector in the first direction after the removing of the tubular structure from the insertion hole.

8. The robot according to claim 1, wherein the circuitry is configured to, in the advancing of the end effector:
control the robot to, upon detection of a force equal to or greater than the first threshold by the force sensor, withdraw the end effector until the force sensor detects a force smaller than the first threshold;
control the robot to, after the withdrawing of the end effector, move the end effector in a direction different from the direction of advancement and withdrawal of the end effector; and
control the robot to advance the end effector after the moving of the end effector.

9. The robot according to claim 8, wherein the circuitry is configured to, in the withdrawing of the end effector, cause the robot to withdraw the end effector through a second distance smaller than the first distance.

10. A method of operating a robot configured to hold a terminal and insert the terminal into a connector having insertion holes to produce a wire harness, wherein the robot includes an end effector including a tubular structure and a force sensor, the tubular structure provided with a slit extending in an extension direction of the tubular structure, the tubular structure is bendable relative to the extension direction, wherein the insertion holes of the connector are stepped to have a smaller opening area at one end of the connector than at the other end of the connector, wherein the terminal is shaped as a pin or tube, has an outer peripheral surface provided with a projection, and has a proximal end to which a wire is connected, wherein the tubular structure has an internal space into which the wire and the terminal are inserted, and has a distal end to contact the projection of the terminal, the method comprising:
controlling the robot holding the terminal to insert the terminal into the insertion hole;
controlling the robot to, after the inserting of the terminal, position an outer peripheral surface of the distal end of the tubular structure horizontally and bend the tubular structure at a predetermined angle; and
controlling the robot to, after the positioning of the outer peripheral surface of the distal end and bending of the tubular structure, advance the end effector through a first distance that is predetermined.

11. The method according to claim 10, wherein the distal end of the tubular structure is tapered.

12. The method according to claim 10, wherein the insertion holes of the connector are arranged in a direction perpendicular to the extension direction.

13. The method according to claim 10, wherein the insertion holes of the connector are arranged in a circumferential direction of the connector.

14. The method according to claim 10, wherein the positioning of the outer peripheral surface of the distal end and bending of the tubular structure includes:
controlling the robot to angularly move the tubular structure in a first direction about a first point of the tubular structure through a first angle that is predetermined, the first direction being opposite to a direction in which the slit is located; and
controlling the robot to, after the angularly moving of the tubular structure, angularly move the tubular structure in the first direction about the distal end of the tubular structure through a second angle that is predetermined and thereby position the outer peripheral surface of the distal end of the tubular structure horizontally.

15. The method according to claim 10, further comprising:
controlling the robot to, after the advancing of the end effector, remove the tubular structure from the insertion hole if the force sensor detects a force smaller than a first threshold that is predetermined.

16. The method according to claim 15, further comprising:
controlling the robot to move the end effector in the first direction after the removing of the tubular structure from the insertion hole.

17. The method according to claim 10, wherein the advancing of the end effector includes:
controlling the robot to, upon detection of a force equal to or greater than the first threshold by the force sensor, withdraw the end effector until the force sensor detects a force smaller than the first threshold;
controlling the robot to, after the withdrawing of the end effector, move the end effector in a direction different from the direction of advancement and withdrawal of the end effector; and
controlling the robot to advance the end effector after the moving of the end effector.

18. The method according to claim 17, wherein the withdrawing includes causing the robot to withdraw the end effector through a second distance smaller than the first distance.

19. A robot configured to hold a terminal and insert the terminal into a connector having insertion holes to produce a wire harness, the terminal being shaped as a pin or tube, having an outer peripheral surface provided with a projection, and having a proximal end to which a wire is connected, the insertion holes of the connector being stepped to have a smaller opening area at one end of the connector than at the other end of the connector, the robot comprising:
an end effector including a tubular structure and a means for sensing force, the tubular structure including a slit extending in an extension direction of the tubular structure, the tubular structure is bendable relative to the extension direction; and
means for controlling
wherein the tubular structure has an internal space into which the wire and the terminal are inserted, and has a distal end to contact the projection of the terminal, and
wherein the means for controlling:
controls the robot holding the terminal to insert the terminal into the insertion hole;
controls the robot to, after the inserting of the terminal, position an outer peripheral surface of the distal end of the tubular structure horizontally and bend the tubular structure at a predetermined angle; and
controls the robot to, after the positioning of the outer peripheral surface of the distal end and the bending of the tubular structure, advance the end effector through a first distance that is predetermined.

20. The robot according to claim 19, wherein the distal end of the tubular structure is tapered.
